(19) United States
(12) Patent Application Publication
(10) Pub. No.: US 2010/0310171 A1
(43) Pub. Date: Dec. 9, 2010

(54) METHOD AND APPARATUS FOR ANALYSIS OF A DATABASE

(75) Inventor: Udo Miletzki, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/793,723

(22) Filed: Jun. 4, 2010

(30) Foreign Application Priority Data
Jun. 5, 2009 (DE) 10 2009 023 959.6
Jun. 10, 2009 (DE) 10 2009 025 018.2

(51) Int. Cl. G06F 17/30; G06K 9/18

(52) U.S. Cl. 382/182; 707/758; 707/E17.009

(57) ABSTRACT

A method for analyzing at least one database which contains a multiplicity of reference data items, in particular for determining the quality of the database in which, in the case of a data field which has a multiplicity of objects each having one information item, data elements are determined from the data field and these are checked and confirmed by comparison with the reference data items and comparison results resulting from this are recorded. It is proposed that a legibility degree is determined for at least some of the data elements, and a state of the database is determined automatically on the basis of the legibility degree and the comparison results.

### CROSS-REFERENCE TO RELATED APPLICATION

This application claims the priority, under 35 U.S.C. §119, of German application Nos. DE 10 2009 023 959.6, filed Jun. 5, 2009 and DE 10 2009 025 018.2, filed Jun. 10, 2009; the prior applications are herewith incorporated by reference in their entireties.

### BACKGROUND OF THE INVENTION

### Field of the Invention

The invention relates to a method and an apparatus for analysis of at least one database which contains a multiplicity of reference data items, in particular for determining the quality of the database.

Address reading systems which are used, for example, in installations for automatic sorting of postal items automatically read addresses, for example addresses on documents, in particular postal items. Depending on the configuration of an address reading system such as this, required distribution information for sorting can be derived from this.

Normally, such address reading systems contain databases, also referred to as address databases, in which reference data items are stored. In general, it is possible for the address of a document or of a postal item not to be identified by the address reading system when addresses on postal items are read automatically, as a result of incomplete addresses, incorrect addresses and/or poorly legible addresses. Furthermore, it is likewise possible for the address of a document or of a postal item not to be identified because of an incomplete database, for example because of the lack of new addresses, old addresses, addresses which have not been updated, or incorrect address inputs.

Previous analyses of an address database relate in general to the overall rejection rate, that is to say the proportion of those addresses read on letters which is not found in the database. The poorer the database is, the higher is the rejection rate and the poorer the hit rate.

Published, non-prosecuted German patent application DE 10 2004 030 415 A1, corresponding to U.S. patent publication No. 2008/0294377 A1, discloses a method for automatic determination of operative performance data of reading systems, in which video coding results and assessment results are stored associated with a respective postal item identification, and statistical evaluations are carried out in order to determine rejection or reading rates, with respect to the overall system of legibility of the postal item addresses and reading results of an OCR reader and/or parts thereof and/or with respect to operative coding services and/or in order to determine the frequency of postal item addresses which are ambiguous, cannot be interpreted or cannot be read.

European patent EP 1 196 886 B1, corresponding to U.S. Pat. No. 6,885,758 B1, discloses a method for forming and/or updating dictionaries relating to automatic address reading, in which classes of words or associated word groups are formed on the basis of reading results of addresses.

### SUMMARY OF THE INVENTION

It is accordingly an object of the invention to provide a method and an apparatus for analysis of a database which overcome the above-mentioned disadvantages of the prior art methods and devices of this general type. The invention is based on the object of specifying an improved method and an improved apparatus for analysis of a database, in particular for determining a quality of the database.

The object according to the invention is therefore achieved in that data features are determined from raw data and are checked and confirmed by comparison with the reference data items, and comparison results resulting from this are recorded and, if appropriate, are temporarily stored, wherein a state, in particular the quality, of the database is determined automatically on the basis of the comparison results and/or parameters derived from them.

In the case of the method for analysis of at least one database which contains a multiplicity of reference data items, in the case of a data field which has a multiplicity of objects each having one information item, data elements are determined from the data field and these are checked and confirmed by comparison with the reference data items, and comparison results resulting from this are recorded. According to the invention, a legibility degree is determined for at least some of the data elements, and a state of the database is determined automatically on the basis of the legibility degree and the comparison results.

A novel method such as this for determining the quality of a database makes it possible to identify and to rectify possible faults in the database, that is to say incorrect or missing entries, during the reading and extraction of data elements and their data features, thus allowing an improved recording process by association of data elements with reference data items.

The data elements are compared with the reference data items. The numbers of hits and misses are used as the basis for the calculation of the state or the quality of the database for a representative set of objects. In order to keep undesirable effects of OCR errors low and in particular to preclude them, an estimate of the legibility degree is also included in the calculation of the state. Expediently, only those data fields whose data elements are clear and can be read well are used for state determination. This makes it possible to ensure reliable monitoring and analysis of the quality of a database, so that it is possible to identify whether the database is largely complete, also with an increasing size and increasing reading ages, and is provided with correct data items. It is possible to continuously monitor whether it is necessary to update the database.

The data items required to determine the legibility degree can be derived from one or more intermediate results of the identification of an automatic reading system, as a result of which no particular hardware complexity is required.

The objects are preferably postal items or documents. The method is therefore preferably used for reading addresses and/or inscriptions on postal items and/or documents, in particular for sorting postal items on the basis of the recorded and read addresses, which can also be associated. The database may be an address dictionary or an address database in which the addresses of a multiplicity of postal item recipients are stored. The data field relating to the objects may be a region of interest (ROI) or an address field in which a delivery address is quoted. The data field may contain an address, which may be referred to as a data record.

The data elements may be first data elements in the form of raw data, which are alphanumeric characters, that is to say letters and/or digits, including special characters. These may be the characters in an ASCI or UNICODE character set. Alternatively or additionally, the data elements may be second data elements in the form of data features which have been obtained from the raw data. Data features may be addresses or address parts, such as a zip code, a local area, a road, a company or a name of a postal item recipient.

The data elements are expediently determined from the data field by optical character recognition (OCR). Voice recognition is likewise possible, if the information items in the data field are read using a voice recognition device. During the comparison process, the data elements, expediently the data features, are compared with the reference data items in the database. During this process, each data field may form a data record, and the reference data items may be subdivided into reference data records, such that the data records can be compared with the reference data records, and the expression of a hit can be used if they correspond or are identical, thus confirming the data elements. If no reference data record which corresponds to a data record can be found, this can be referred to as a miss. The comparison can be carried out in partial comparison processes, in each of which a portion of the data record is compared with a corresponding portion of the reference data records.

The legibility degree may be a legibility degree of raw data, that is to say for example ASCII characters, of data record parts or of the entire data record. It may be obtained from values from the OCR, for example from the OCR quality of raw data, data record parts or the entire data record.

The legibility degree is expediently determined from the raw data, and the data features are compared with the reference data items. This makes it possible to use different information parts, for example address parts, for determination of the legibility degree than those used for the comparison. In particular, it is possible to filter out a portion of the data elements which are required for the comparison, and to use only the remaining portion of the data elements for determining the legibility.

In one advantageous embodiment of the invention, only information items from those data fields, for example from those objects, whose data elements have a legibility degree above a minimum quality are considered for determining the state of the database. The legibility degree may be the overall legibility degree of the data elements together, for example of the entire data record, for example the entire address.

Furthermore, preferably, a number of data hits is determined, for example from the comparison results, for which the associated data elements have a legibility degree above a minimum quality and for which associated reference data items are found. Each data field may form a data record, and the number of data hits may be the number of data records for which a hit is found in the reference data items.

Furthermore, in one development of the invention, the number of data hits is determined for which reference data items associated with raw data and/or their data features are found. In other words: those data hits which can be verified by reference data items stored in the database are determined for a plurality of documents or postal items. The number of data hits therefore corresponds to the number of easily legible data records which can be associated with the reference data items.

Expediently, a completeness degree of the database is determined as a state parameter on the basis of data hits. In a further preferred embodiment of the invention, the number of all the data elements which are legible but cannot be associated is determined. This means that those data elements are determined for which the legible data elements have data elements which cannot be evaluated, cannot be interpreted or are ambiguous for a comparison with the stored reference data items. In addition, these may be those data elements for which there are no reference data items in the database. Once again, raw data of a minimum quality is used as the basis for the legible data elements, in this case. That number of data elements which are easily legible but cannot be associated therefore also indicates a measure of the quality of the database.

A further or alternative embodiment of the invention provides for the number of all the unused reference data items to be determined. This means that those unused reference data items are determined with which, for example, it has also not been possible to associate any determined data elements over a predeterminable time period. By way of example, unused reference data items such as these may be incorrect reference data items, for example reference data items which have been entered incorrectly, are false and/or old reference data items. That number of unused reference data items therefore indicates a measure for the quality of the database, in particular for a so-called contamination thereof with unrequired reference data items and possible invalid reference data items which interfere with the association process. A purity degree is expediently determined as a state parameter, such that at least the sum of all the used reference data items or the unused reference data items, or reference data records, are set as a ratio to the sum of all the reference data items or reference data records.

The state of the database is determined for complete analysis of the database and complete definition of its quality, such that the product of the determined completeness degree and the determined purity degree is determined, and is compared with a predetermined limit value. In this case, the state of the database can initially be set to the value which assesses the database as a complete database, without any faults.

With regard to the apparatus for analysis of the database, this apparatus contains an automatic reading system or OCR system for recording data elements, as well as an analysis unit which tests and confirms the data elements by comparison with the stored reference data items, temporarily stores comparison results which result from this, and automatically determines a state of the database on the basis of the temporarily stored comparison results and/or parameters derived from them.

The reading system is preferably an optical reading system, in particular a so-called OCR reader. In this case, the raw data contained in a data field of a postal item or a document is read by the OCR reader in a conventional way, and its image is examined for data features, which are extracted. In particular, in this case, those data elements are identified and assessed as being legible whose characters have a minimum quality, in order to make it possible to extract data features from raw data.

Other features which are considered as characteristic for the invention are set forth in the appended claims.

Although the invention is illustrated and described herein as embodied in a method and an apparatus for analysis of a database, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram showing an apparatus for analysis of a database according to the invention;

FIG. 2 is a flowchart for explaining a method for analysis of the database; and

FIG. 3 is an illustration of an object in a form of a letter.

### DETAILED DESCRIPTION OF THE INVENTION

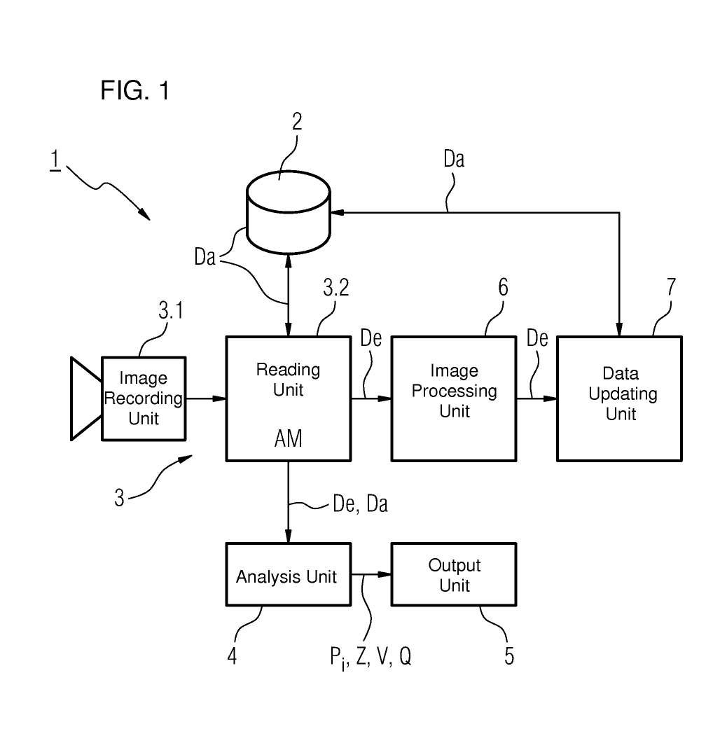

Mutually corresponding parts are provided with the same reference symbols in all the figures. Referring now to the figures of the drawing in detail and first, particularly, to FIG. 1 thereof, there is shown an apparatus 1 for analysis of a database 2. By way of example, the database 2 may be an address database for a sorting and distribution installation for postal items, for example letters. Reference address data items are stored with associated data features, such as the zip code, locality, road, addressee, for this purpose as reference data items Da in the database 2.

In order to analyze the database 2, the apparatus 1 has a reading system 3, in particular an optical reading system, which has an image recording unit 3.1, for example a camera, for recording a monochrome image of an object, for example a postal item, such as a letter or a package. The monochrome image is passed to a reading unit 3.2, in particular an OCR reader, for extraction of data elements De, for example data features AM, from raw data.

The apparatus 1 furthermore contains an analysis unit 4 which tests and confirms the data elements De by comparison with the stored reference address data items Da, or outputs a miss. The resulting comparison results V may contain the identity of data elements with reference data items or data records with reference data records. The comparison results V may be temporarily stored in a data memory unit which is not illustrated in any more detail. A state Z of the database 2 is then determined automatically by the analysis unit 4, on the basis of the comparison results V and/or parameters Pᵢ derived from them.

For this purpose, by way of example, a multiplicity of data items De, for example at least 100 postal items, can be supplied to the analysis unit 4 for testing and determining initial values of the parameters Pᵢ and the state Z of the database 2. The comparison results V and/or the parameters Pᵢ and/or the determined state Z can furthermore be output via an output unit 5, for example a screen or a printer, in alphanumeric and/or graphic form.

Furthermore, the apparatus 1 may contain an image processing unit 6 which stores and manages all the images recorded by the image recording unit 3.1, for further image processing processes. In this case, the image processing unit 6 may be connected, as illustrated, to the reading unit 3.2. Alternatively or additionally, the image processing unit 6 can be connected directly to the image recording unit 3.1.

The image processing unit 6 can optionally be connected to a data updating unit 7 (also referred to as learnt data unit). The data updating unit 7 uses data fields from postal items to identify those data elements De which have not yet been included in the database 2, as well as those reference data items which have not been used for a comparison. Once a predeterminable time has elapsed and/or once a predeterminable minimum number of reference address data items Da to be updated and/or to be added has been exceeded in the database 2, the data updating unit 7 automatically updates the database 2, with the determined new data elements De being inserted as new reference data items Da in the database 2 and/or unused reference address data items Da being withdrawn, for future comparisons, for example by storing them in a special database region.

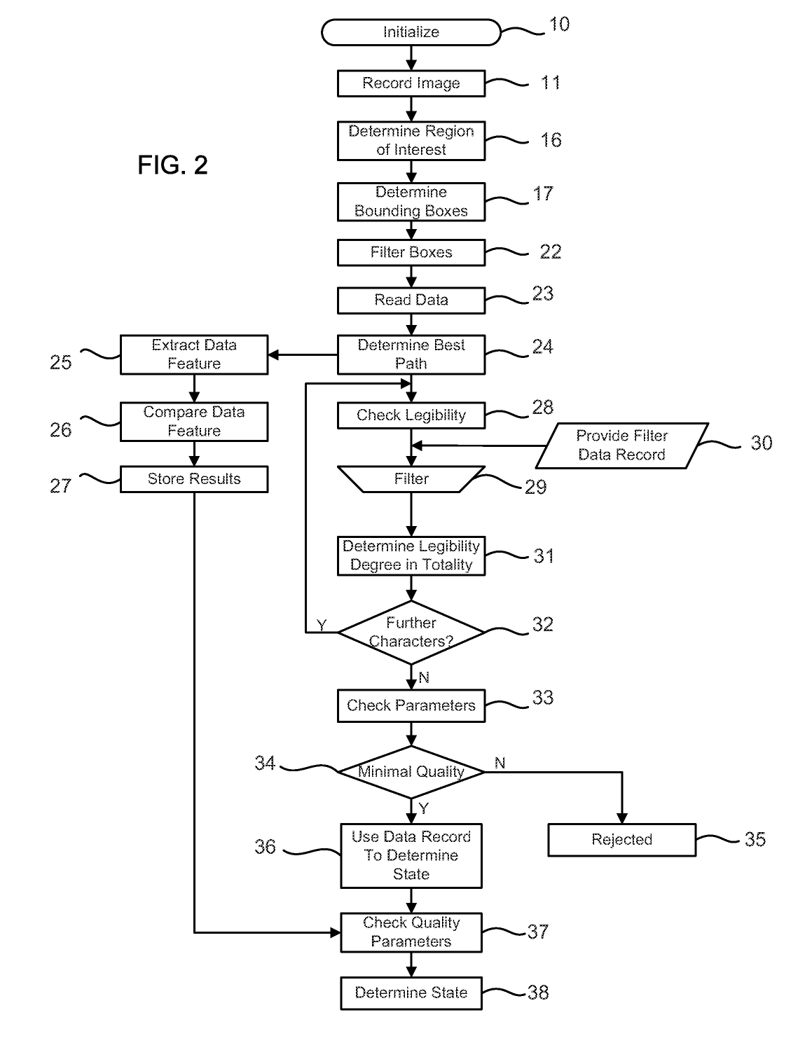

The method for analysis and determination of a state Z of the database 2 will be explained in more detail in the following text with reference, by way of example, to the flowchart in FIG. 2. The method for determining the state Z, in particular a quality Q, of the database 2 can be implemented as a computer program in the analysis unit 4.

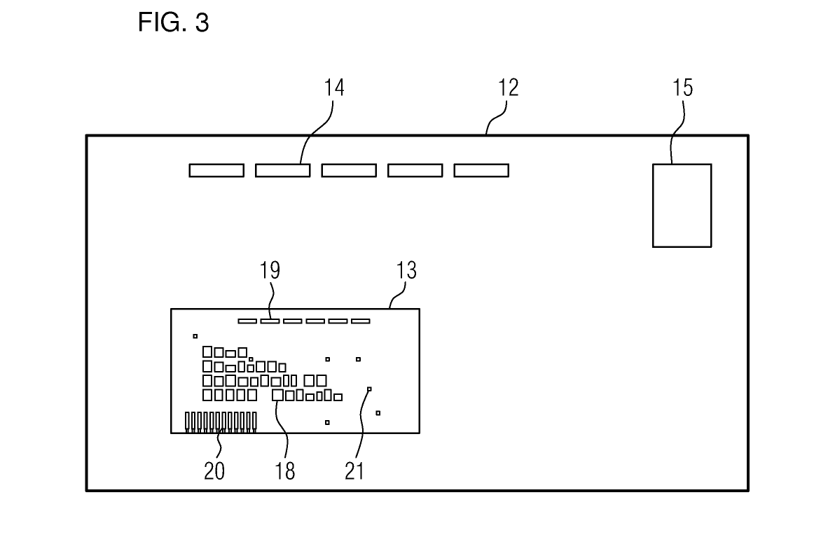

In order to start 10 the method, counters and status indicators are initialized by zeros. In step 11, an image of an object is recorded by the camera 3.1, and is supplied as a monochrome image to the reading unit 3.2 and to the image processing unit 6. One object 12 is illustrated, by way of example, in FIG. 3 and contains an address field 13, also referred to as a region of interest (ROI), which has a data record with a delivery address, further text fields 14 in which advertising is printed, and a postage stamp 15. The ROI is determined by image recognition in step 16. In step 17, the so-called bounding boxes (BB) are then determined in the ROI, in which there is printed text which is identified by the reading unit 3.2 as a possible data element De.

As can be seen from FIG. 3, the BBs do not all actually contain address elements. In addition to those bounding boxes 18 which contain address elements, there are bounding boxes 19 which contain further elements, for example small printed advertising or just bars, furthermore bounding boxes 20 which contain bars of a bar code and, finally, bounding boxes 21 which contain spots or image recognition errors. The bounding boxes 18-21 are filtered in step 22 in order to segregate the bounding boxes 19, 20, 21 which are of no interest. In this case, all the bounding boxes 19-21 whose area is less than, for example, 1 mm² are segregated, thus eliminating the bounding boxes 21, and/or whose height to width ratio is less than 0.25 or more than 4, thus eliminating the bounding boxes 19 and 20.

In step 23, the raw data is now read from the bounding boxes 18 by OCR. During this process, one or more bounding boxes 18 is or are normally associated with a plurality of characters with different OCR qualities, thus making it possible to form a multiplicity of paths, with each path representing one possible character string. Each path contains a plurality of characters or raw data items, which are each provided with an OCR quality. The best path, for example for an address line or the data record containing the entire address, can now be determined in step 24 from the OCR qualities, for example that which has the highest mean value of the OCR qualities of all the characters.

In step 25, the data features, for example the zip code, locality, road and building number or postal item recipient, can be extracted from the raw data. These data features are compared with the reference data items Da, in step 26. A comparison result may be a hit or a miss. For example, when there are a number of objects, for example 10,000 objects, a sum of hits and misses is determined which is equal to the given number. In step 27, the comparison results, for example the hits and misses, are stored associated with the respective data records. The objects can be sorted, for example on the basis of destination, using the hits.

In order to determine a legibility degree for the characters in the data records, the legibility degree of one character is checked in a step 28. This legibility degree may be an OCR quality which the OCR process has output for this character, to be precise the OCR quality of the best path. It is possible to determine whether the legibility degree is greater than a first threshold value. The character is subjected to filtering in step 29. A filter data record 30 with characters to be filtered out is provided for this purpose. Characters such as these are all characters which are similar to points and bars, such as {! [symbol] _. . . }. For example, if the destination of the postal item is 89257 Illertissen, then, although the character string “89257 Illertissen” is used for the comparison, only the character string “89257 ert ssen” is used to determine the legibility degree.

The aim of this filter step is to ensure that there is a very high probability of not using any bar characters or point characters, which are not associated with the address, for determining the state of the database. For example, if there are a number of spots of dirt in the address field, then, for example, these are interpreted as punctuation marks. In the worst case, it will now not be possible to associate any database address with the address, thus resulting in a miss. However, if the OCR quality of the points is very high, then it is possible to draw the incorrect conclusion that the address which intrinsically makes no sense because of the dots is easily legible, and this will be used for adding to the database. It is essential to avoid this.

The legibility degree of the totality of the characters is determined in the following step 31. In the case of the first character, this is the legibility degree of the first character. Since a check is carried out in step 32 to determine whether there are also further characters in the data record or in a data record part such as an address line, and if yes steps 28-31 are repeated, the legibility degree of the totality of characters changes with each character. The legibility degree can therefore be determined as the average legibility degree or average OCR quality of all the characters recorded in the loop. Other calculations are also possible.

Once all the characters have been recorded, three parameters are checked in step 33. For the parameter a, a check is carried out to determine whether the legibility degree of all the characters is above the first threshold value, for example above 0.8. For the parameter b, a check is carried out to determine whether the legibility degree of all the characters or the overall legibility degree is above a second threshold value, for example above 0.95. Finally, for the parameter c, a check is carried out to determine whether the legibility degree of all the characters is within a third threshold value, for example within 0.15. These three parameters can be used to define a minimum quality of the legibility degree, for example by one, two or all of the parameters having to be above or within the threshold values. The check as to whether the minimum quality is present is carried out in step 34. If the legibility of the data record or of a part of it is at or below the threshold value, the data record is rejected in step 35, and is not used to determine the state of the database 2. If the legibility is above the threshold value, the data record is used in step 36 in order to determine the state of the database 2.

For this purpose, two state parameters or quality parameters Pᵢ of the database are checked in step 37, specifically: the completeness P₁ and the purity P₂. This can be done for each data record, as a result of which the two parameters Pᵢ change with each data record. It is also possible to determine the parameters Pᵢ only after accumulation of the predetermined number of objects. The parameters Pᵢ can be calculated as follows:

$${P}_{1} = \frac{{N}_{legible}^{hit}}{{N}_{legible}}$$

$${P}_{2} = 1 - \frac{{N}_{Da}^{unused}}{{N}_{Da}}$$

where P₁={0 . . . 1} and P₂={0 . . . 1} and
a) N_{legible}: all data records with a legibility degree above the minimum quality
b) N^{hit}_{legible}: all the data records with a legibility degree above the minimum quality which have led to a hit
c) N_{Da}: all the reference data records in the database
d) N_{Da}^{unused}: all the reference data records in the database which have not led to a hit.

Step 26 determined whether a hit relating to a data record or a part of it has occurred. In this case, the knowledge is also available as to which data records or reference data items Da in the database 2 have already led to a hit, and which have not yet done so. By way of example, it is possible to determine whether a hit has occurred over a waiting time period of 3 months, or over a specific number of checked data records.

In step 38, the state Z of the database is determined using the formula:

Z=P₁*P₂.

This state Z, which is a product of completeness and purity, indicates a quality Q of the database.

For an initial database, the completeness P₁ and the purity P₂ are set to unity, since the sum of all the unused or non-used reference address data items Da is equal to zero, and no faulty reference address data items Da are included. As the faults in the database 2 increase, the completeness P₁ and the purity P₂ decrease. Analogously to this, the initial database 2 is a complete database, which has no impurities and thus is not subject to any faults. The quality Q is unity. Therefore all the easily legible raw address data items De and/or address features AM can be associated with reference address data items Da.

The present method allows a simple, automatic method for determining a quality of the database 2 independently of the use of the database.

1. A method for analysis of at least one database having a multiplicity of reference data items and in a case of a data field containing a multiplicity of objects each having one information item, which comprises the steps of:
determining data elements from the data field;
checking and confirming the data elements by comparing the data elements with the reference data items resulting in comparison results;
recording the comparison results;
determining a legibility degree for at least some of the data elements; and
determining a state of the database automatically on a basis of the legibility degree and the comparison results.

2. The method according to claim 1, wherein the data elements contain first data elements in a form of raw data and second data elements in a form of data features obtained from the raw data, and the method further comprises:
determining the legibility degree from the raw data; and
comparing the data features with the reference data items.

3. The method according to claim 1, which further comprises:
filtering out a portion of the data elements which are required for a comparison; and
using only a remaining portion of the data elements for determining the legibility degree.

4. The method according to claim 1, which further comprises:
recording OCR quality of each of the data elements in the data field; and
determining the legibility degree in dependence on the OCR qualities recorded.

5. The method according to claim 4, which further comprises determining the legibility degree from a mean value of the OCR qualities recorded.

6. The method according to claim 1, wherein only the information items from the data fields whose data elements have the legibility degree above a minimum quality are considered for determining the state of the database.

7. The method according to claim 6, which further comprises recording the legibility degree of each the data elements in the data field of the object, and a minimum quality is achieved only when a mean value of all the legibility degrees is above a threshold value.

8. The method according to claim 6, which further comprises recording the legibility degree of each of the data elements in the data field of the object, and a minimum quality is achieved only when each of the legibility degrees determined is above a threshold value.

9. The method according to claim 6, which further comprises recording the legibility degree of each of the data elements in the data field of the object, and a minimum quality is achieved only when any fluctuation in the legibility degrees determined is below a threshold value.

10. The method according to claim 1, which further comprises determining a number of data hits for which the data elements have the legibility degree above a minimum quality and for which of the reference data items are found.

11. The method according to claim 10, which further comprises determining a completeness degree of the database as a state parameter on a basis of a determined number of the data hits and a number of all the data elements with the legibility degree above a minimum quality.

12. The method according to claim 11, which further comprises determining a purity degree of the database as a state parameter from a sum of one of all the used reference data items and all the unused reference data items, as a ratio to a sum of all the reference data items.

13. The method according to claim 12, which further comprises determining the state from a product of the completeness degree and the purity degree.

14. The method according to claim 1, which further comprises determining a quality of the database.

15. An apparatus, comprising:
an automatic reading system for recording data elements;
an analysis unit for analysis of at least one database having a multiplicity of reference data items and in a case of a data field containing a multiplicity of objects each having one information item, said analysis unit programmed to:
determine data elements from the data field;
check and confirm the data elements by comparing the data elements with the reference data items resulting in comparison results;
record the comparison results;
determine a legibility degree for at least some of the data elements; and
determine a state of the database automatically on a basis of the legibility degree and the comparison results.

16. The apparatus according to claim 15, wherein said automatic reading system has at least one OCR reader.
